(19) United States
(12) Patent Application Publication
(10) Pub. No.: US 2025/0290512 A1
(43) Pub. Date: Sep. 18, 2025

(54) Driving Device for Manual Rotary Fluid Pump

(71) Applicants: Solomon Chang, Taipei City (TW); Fang-Yu Wang, New Taipei City (TW)

(72) Inventor: Solomon Chang, Taipei City (TW)

(21) Appl. No.: 18/740,542

(22) Filed: Jun. 12, 2024

(30) Foreign Application Priority Data
Mar. 13, 2024 (TW) 113202520

(51) Int. Cl. F04C 29/00; B25B 23/00

(52) U.S. Cl. CPC F04C 29/0071; B25B 23/0035

(57) ABSTRACT

The improved driving device for manual rotary fluid pump of the present invention refers to the improvement of the shaft portion that performs the liquid extraction operation inside the pump body. The structural design mainly includes an adapter device at the end of the shaft portion for coupling with the chuck of the automatic tool, allowing users to use the automatic tool to replace conventional manual rotation operations, thereby improving work efficiency and reducing the burden of manual operations.

### BACKGROUND OF THE PRESENT INVENTION

### Field of Invention

The present invention relates to a manual rotary fluid pump for extracting a large amount of liquid. The end of the shaft portion of the pump body is designed to be connected to a chuck of an automatic tool through the structural design of an adapter device, allowing the user to utilize automated tools to replace conventional manual rotating operations.

### Description of Related Arts

As we all know, the industrial revolution is nothing more than replacing manual labor with machinery to improve production efficiency. Motors are one of the most important technologies in the industrial revolution. With the advancement of technology, especially the development of electricity, motor driven by electricity has gradually become the power source to replace human labor, accelerating the rapid development of industrialization.

Currently, the operating method of manual rotary fluid pump on the market still driven by manual rotation. The main reason is that there is no need to rely on external energy supply. The pump can be started by manually rotating or operating the handle. It is easy to use and does not require complicated installation processes.

Since the conventional manual rotary fluid pump is usually simple in design, intuitive to operate, and does not want to be restricted by the environmental conditions of the use of electricity, there is still considerable demand for outdoor workers.

However, the conventional manual rotary fluid pump (refer to FIGS. 1 and 2) mainly includes a pump body 1, which has an extraction end 11 extending downward on the side thereof as a tube for placed in the source to be extracted, and an output end 12 extending upward as a pipe for liquid extraction and output. The pump body 1 has a shaft portion 10 located adjacent to the center thereof, which drives the internal extraction operation of the pump body 1, and has a cross-section 101 at the end thereof in the form of a half-moon-shaped rod, which is correspondingly inserted through a fixing hole 132 of a hand crank 13. After the hand crank 13 is engaged with the shaft portion 10, it is locked in a perforation 134 with a screw 133. At that time, the user can use a grip 131 at the end of the hand crank 13 to rotate and complete the liquid extraction of the pump body 1.

Since this type of manual rotary fluid pump is mostly used to pump large amounts of liquid, it requires continuous and continuous manual operation by the operator. The operator needs to continuously rotate the hand crank 13 to complete the extraction operation. Especially in the case of long-term or large-scale operations, the operator's work intensity increases, which may lead to fatigue and a decrease in work efficiency. If the rotary operation can be improved to automatic or electric drive, labor costs will definitely be saved.

### SUMMARY OF THE PRESENT INVENTION

In view of the above shortcomings, the inventor has devoted himself to research and improvement, utilizing conventional automatic tools such as handheld pneumatic tools and handheld electric tools, and with the structural improvement and application of correspondingly connected adapter devices, a manual rotary fluid pump can be provided with automatic operation functions, thereby reducing the operator's labor burden.

Therefore, the main purpose of the present invention is to provide a manual rotary fluid pump with an operating function of automatic rotation, which can be implemented by using conventional automatic tools and adapter devices, to achieve the replacement of conventional manual rotation with automatic tools.

### BRIEF DESCRIPTION OF THE DRAWINGS

The present invention will be further described below in conjunction with the accompanying drawings and examples.

FIG. 1 is a perspective view of a conventional manual rotary fluid pump.

FIG. 2 is an exploded view of the conventional manual rotary fluid pump.

FIG. 3 is a perspective view of a preferred embodiment of the present invention.

FIG. 4A is a perspective view of another sleeve embodiment of the present invention.

FIG. 4B is a perspective view of another sleeve embodiment of the present invention.

FIG. 5 is a perspective view of another shaft portion embodiment of the present invention.

FIG. 6 is a sectional view of four embodiments of the shaft portion and extension rod of the present invention.

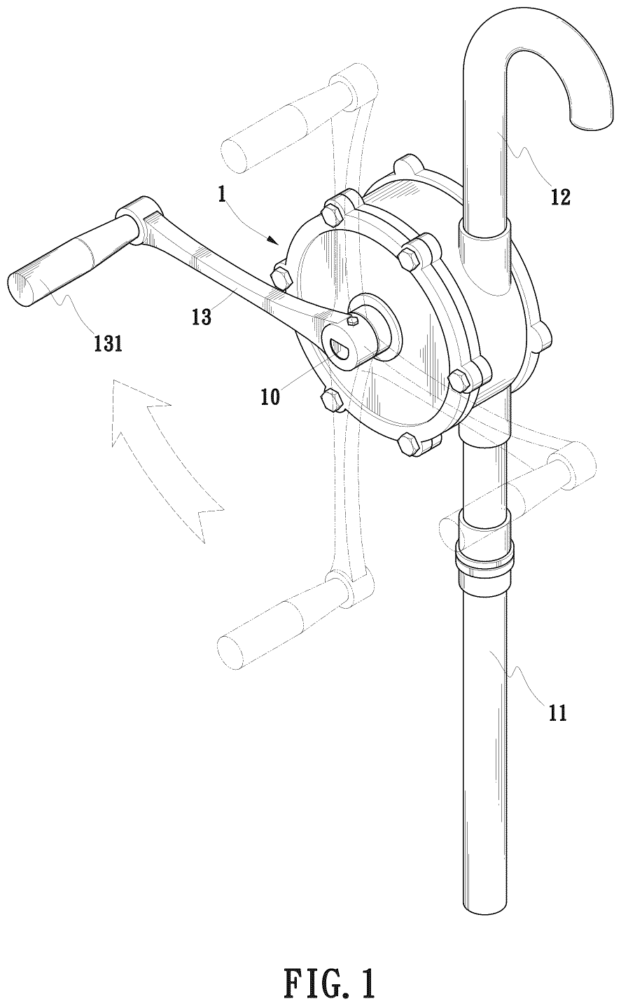

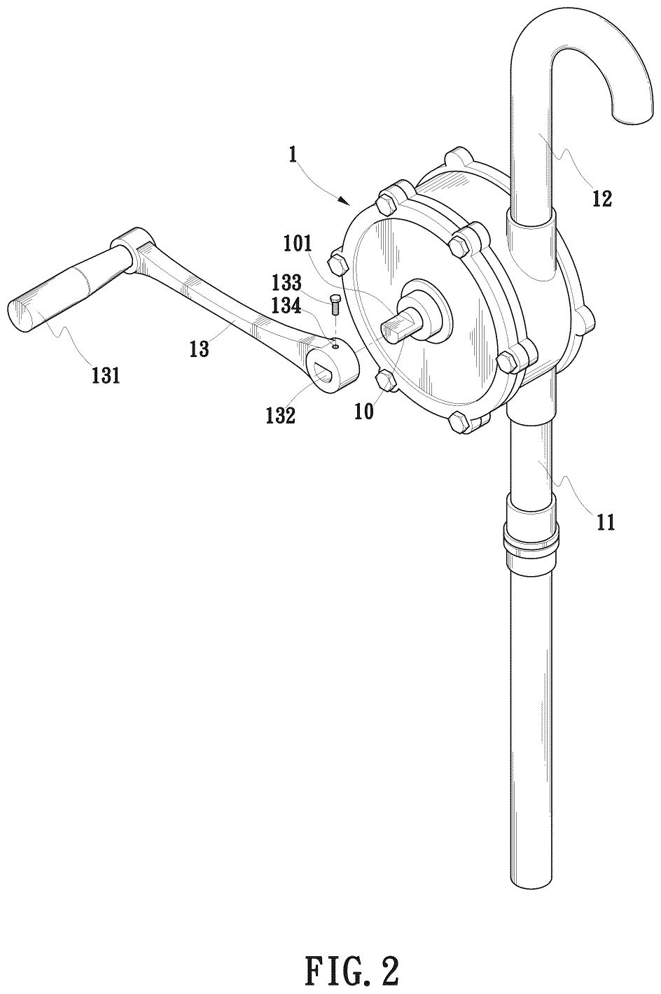

### DETAILED DESCRIPTION OF THE PREFERRED EMBODIMENT

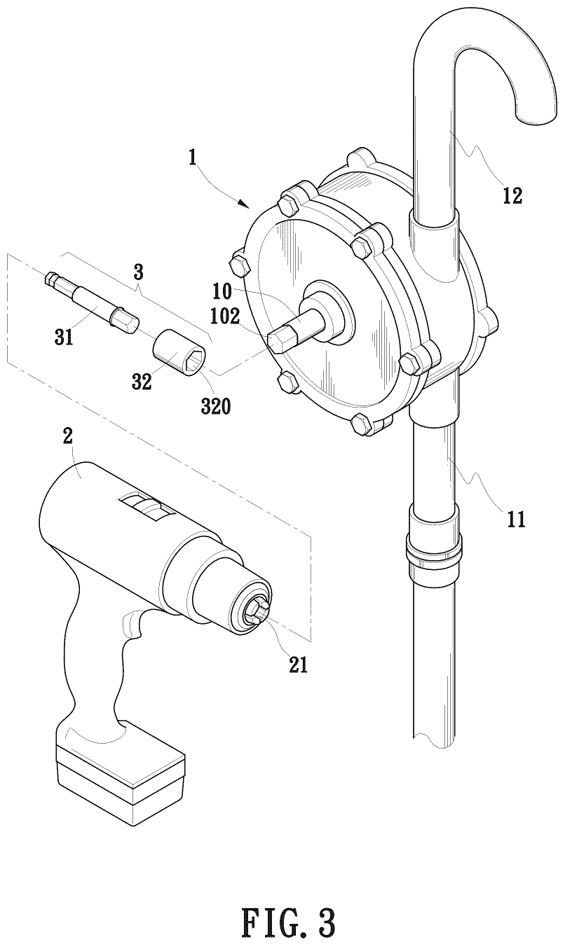

First, referring to FIG. 3, the main feature of the improved driving device for manual rotary fluid pump of the present invention is that a coupling portion 102 at the end of a shaft portion 10 of a pump body 1, which is a hexagonal rod. The coupling portion 102 is connected to an adapter device 3 so as to be clamped and fixed with a chuck 21 of an automatic tool 2 for transmission of rotational power. In this way, the automatic tool 2 is capable of completely replacing the original manual rotation and drive the pump body 1 to complete the extraction of liquid.

The adapter device 3 corresponding to the coupling portion 102 of the shaft portion 10, which includes an extension rod 31 and a sleeve 32. The sleeve 32 has a hexagonal groove 320 provided at one end thereof, corresponding to the hexagonal rod of the coupling portion 102. The extension rod 31 is connected behind the other end of the sleeve 32 for clamping and fixing of the chuck 21 of the automatic tool 2.

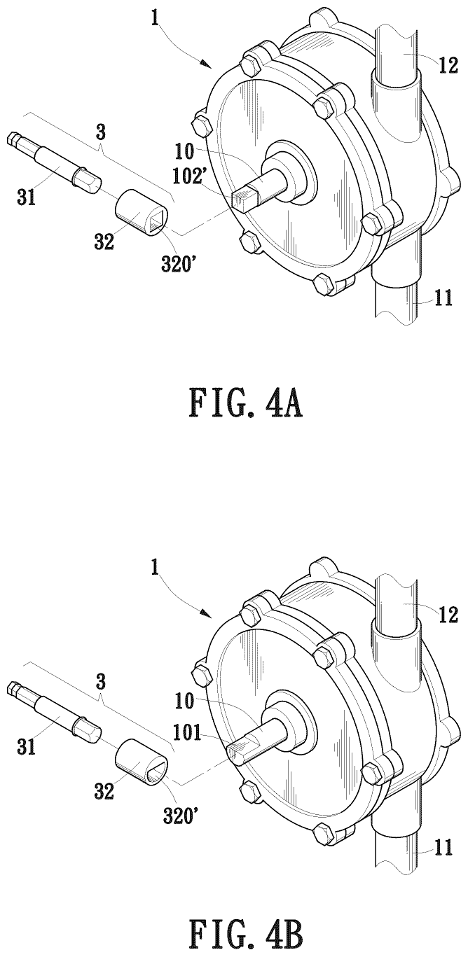

Referring to FIG. 4A, a perspective view of another sleeve embodiment of the present invention is illustrated, wherein the sleeve 32 has a quadrangular groove 320′ provided at one end thereof, corresponding to the quadrangular rod of the coupling portion 102′ of the shaft portion 10, thereby completing the connection of the adapter device 3.

Referring to FIG. 4B, a perspective view of another sleeve embodiment of the present invention is illustrated, wherein the sleeve 32 has a half-moon shaped groove 320′ provided at one end thereof, corresponding to the half-moon shaped rod of the coupling portion 102′ of the shaft portion 10, thereby completing the connection of the adapter device 3.

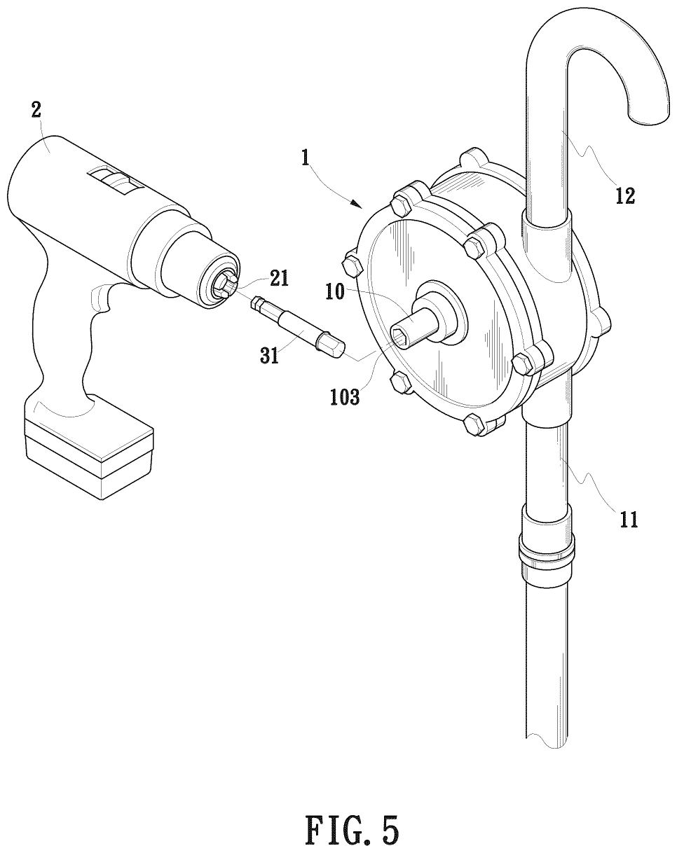

In addition, referring to FIG. 5, which is a perspective view of another shaft portion embodiment of the present invention, where the end of the shaft portion 10 of the pump body 1 has a hexagonal groove 103 directly corresponding to the insertion and connection of the extension rod 31, so that it can be directly clamped and fixed with the chuck 21 of the automatic tool 2.

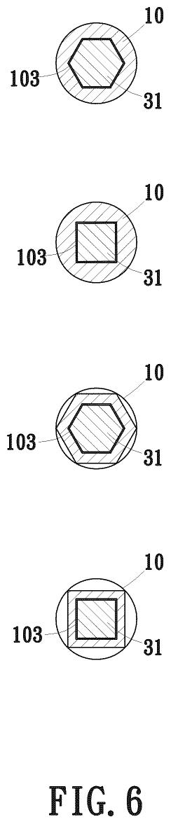

Referring to FIG. 6, which illustrates four embodiments of the shaft portion and the extension rod of the present invention. Based on the above, the groove 103 of the shaft portion 10 of the pump body 1 can be implemented as a hexagonal or quadrangular groove 103, or the end of the shaft portion 10 can be implemented as a hexagonal or quadrangular rod, thereby meeting different types of joint implementations of the shaft portion 10 and the extension rod 31.

The main purpose of the improved driving device for manual rotary fluid pump of the present invention is to provide a component connection of the adapter device 3, which can make the corresponding connection of the shaft portion 10 of the pump body 1 of different specifications, so that the conventional manual rotation operation can be replaced by an automatic tool 2.

The above descriptions are only preferred embodiments of the present invention and are not intended to limit the patentable scope of the present invention. All other equivalent changes or modifications made without departing from the spirit disclosed in the present invention shall be included in the following patent application scope.

What is claimed is:

1. An improved driving device for a manual rotary fluid pump, which is used for extracting liquid, comprising:
a pump body having a shaft portion arranged thereon that drives the internal extraction operation of the pump body;
an automatic tool having a chuck, which is the power source for driving the pump body;
an adapter device comprising an extension rod and a sleeve, wherein the sleeve has a groove provided at one end thereof that corresponds to the shape of the shaft portion of the pump body, and the other end of the sleeve is connected to the extension rod which is fixed into the chuck of the automatic tool, allowing the automatic tool to drive the pump body.

2. The improved driving device for the manual rotary fluid pump, as recited in claim 1, wherein the automatic tool is capable of being an electronically powered tool with the chuck rotational, providing rotational power.

3. The improved driving device for the manual rotary fluid pump, as recited in claim 1, wherein the automatic tool is capable of being an air-powered tool with the chuck rotational, providing rotational power.

4. An improved driving device for a manual rotary fluid pump, which is used for extracting liquid, comprising:
a pump body having a shaft portion arranged thereon that drives the internal extraction operation of the pump body, wherein the shaft portion has a groove provided at the end thereof;
an automatic tool having a chuck, which is the power source for driving the pump body;
an extension rod, one end of the extension rod corresponds to the shape of the shaft portion or the groove of the pump body, and the other end thereof is capable of being inserted into the chuck of the automatic tool to be fixed, so that the power of the automatic tool is capable of driving the pump body.
